(19) United States
(12) Patent Application Publication
(10) Pub. No.: US 2018/0357670 A1
(43) Pub. Date: Dec. 13, 2018

(54) DYNAMICALLY CAPTURING, TRANSMITTING AND DISPLAYING IMAGES BASED ON REAL-TIME VISUAL IDENTIFICATION OF OBJECT

(71) Applicant: INTERNATIONAL BUSINESS MACHINES CORPORATION, ARMONK, NY (US)

(72) Inventors: Lisa Seacat DeLuca, Baltimore, MD (US); Jeremy A. Greenberger, Raleigh, NC (US)

(21) Appl. No.: 15/615,974

(22) Filed: Jun. 7, 2017

(51) Int. Cl. G06Q 30/02; G06K 9/00

(52) U.S. Cl. CPC G06Q 30/0255; G06K 9/00671; G02B 2027/0178; G06Q 30/0267; G06Q 30/0261

(57) ABSTRACT

A method and system for dynamically capturing, transmitting and displaying images for a user of an image capturing device carried by the user. A computer receives, in real-time, image data representing an image of a product, where the image data is received from an image capturing device while said image capturing device is viewing the product. The computer identifies, in real-time, a given product from a catalog of products stored in a database, where identifying the given product is based on the given product substantially matching the image of the product. The computer determines, in real-time, that promotional material exists for the given product. The computer transmits, in real-time, a signal including the promotional material to the image capturing device, where the signal triggers, in real-time, a display of the promotional material by the image capturing device to the user.

### FIELD OF THE INVENTION

The invention relates to delivering advertisements and promotional materials to an augmented reality device in real time based on object identification.

### BACKGROUND

Humans are very visual creatures. Often times people are reminded of something from a quick visual. When it comes to advertising timing is everything. If a user is presented with an advertisement at a time that the user is not likely able to make a purchase the likelihood of a conversion is low. It is not possible however to marry the visual experiences a user is seeing in real time with a set of available advertisements such that the correct advertisement is delivered at a time where it's the most relevant to the user.

Augmented reality is a technology that allows virtual imagery to be mixed with a real world physical environment. An augmented reality system can be used to insert virtual images before the eyes of a user. In many cases, augmented reality systems do not present a view of the real world beyond the virtual images presented.

Product advertising has become focused to user activities both in visiting retail establishments and while visiting on-line shopping sites.

### SUMMARY

The present invention described herein provides various embodiments for dynamically capturing, transmitting and displaying images for a user of an image capturing device carried by the user. A computer receives, in real-time, image data representing an image of a product, where the image data is received from an image capturing device while said image capturing device is viewing the product. The computer identifies, in real-time, a given product from a catalog of products stored in a database, where identifying the given product is based on the given product substantially matching the image of the product. The computer determines, in real-time, that promotional material exists for the given product. The computer transmits, in real-time, a signal including the promotional material to the image capturing device, where the signal triggers, in real-time, a display of the promotional material by the image capturing device to the user.

The device may be an augmented reality visual device worm by a user.

### BRIEF DESCRIPTION OF THE DRAWINGS

FIG. 1A is a block diagram depicting example components of one embodiment of a see-through, mixed reality display device in a system environment in which the device may operate according to an embodiment of the present invention.

FIG. 1B is a block diagram depicting example components of another embodiment of a see-through, mixed reality display device according to the present invention.

FIG. 2 is a side view of an eyeglass temple of the frame for augmented reality eyeglasses according to an embodiment of the present invention.

FIG. 3A is a block diagram of one embodiment of hardware and software components of a see-through, near-eye, mixed reality display unit according to an embodiment of the present invention.

FIG. 3B is a block diagram of one embodiment of the hardware and software components of a processing unit with a see-through, near-eye, mixed reality display unit according to an embodiment of the present invention.

FIG. 4 is a block diagram of a system embodiment for identifying objects using a see-through, near-eye, mixed reality display device according to an embodiment of the present invention.

FIG. 5 is a flowchart of a method embodiment for identifying an object in the wearer's field of view of a see-through, near-eye, mixed reality display device and retrieving a related advertisement for the specific product according to an embodiment of the present invention.

FIG. 6 shows an example of system architecture for one or more processes and/or software for providing augmentation information to a user from a supplemental information provider according to an embodiment of the present invention.

FIG. 7 is a schematic representation of a user's view of an object of interest during a shopping experience according to an embodiment of the present invention.

FIG. 8 is a schematic representation of a user's view of an object of interest during a shopping experience with a displayed promotion according to an embodiment of the present invention.

FIG. 9 illustrates another alternative use of the technology providing augmentation information to a user in which the user has entered a store, such as a furniture store, according to an embodiment of the present invention.

FIG. 10 represents an example of the information provided by selecting an option from the advertisement in FIG. 9 according to an embodiment of the present invention.

FIG. 11 depicts a cloud computing node according to an embodiment of the present invention.

FIG. 12 depicts a cloud computing environment according to an embodiment of the present invention.

FIG. 13 depicts abstraction model layers according to an embodiment of the present invention.

### DETAILED DESCRIPTION

The invention described herein provides various embodiments for implementing an augmented reality method and system that can provide augmented product and environment information to a user. The augmentation information may include advertising, inventory, pricing and other information about products a user may be interested in. Interest is determined from user actions, specifically products being viewed by the user and a user profile. The information may be used to promote real-time purchases of real world products by a user, or allow the user to make better purchasing decisions. The augmentation information may enhance a user's shopping experience by allowing the user easy access to important product information while the user is shopping in a retail establishment.

The invention described herein may include a see-through, near-eye, mixed reality display device for providing customized augmented information in the form of product information and advertising to a user. The system can be used in various environments, from the user's home to public areas and retail establishments to provide a mixed reality experience enhancing the user's ability to live and work. While the invention and examples set forth herein refer to augmented reality glasses, the present invention may be employed using any type of device having a camera or video whether or not the device includes augmented reality capabilities. For example, a user's mobile phone may perform the method and comprise the system of the invention set forth herein.

Augmentation information as described herein may take many forms and include, for example, targeted advertising based on user context and products being viewed by the user in real-time. Using data received from the display device, e.g., a see-through, head-mounted display (STHMD), targeted advertising based on the context of user view and interaction is presented to the field of view of a user. The data may include queuing ads based on time, surrounding audio, place, and user profile knowledge. For example, interactive advertisements may be triggered when a user is proximate to a real world object or walking by billboard.

More specifically, a system and method is disclosed to associate a product with an advertisement such that the advertisement is only shown to a user when the user views the product or an image of the product in real time.

This invention could be added to existing products including IBM Marketing Cloud to allow marketers to specify the display of an advertisement conditionally on a user viewing the product in real time.

To implement the invention according to one embodiment, a set of advertisements are created whereby the advertisement is assigned to a visual image either manually or cognitively. Manual assignment requires a user to manually assign a product image to a related advertisement. Cognitive assignment requires cognitive image recognition technologies that correlate key words within an advertisement to potentially related products. For example, if a retailer desires to promote an advertisement of 50% off purses where no particular brand of purse is mentioned, the cognitive system would be able to correlate the keyword of “purse” and understand the range of product that are purses and/or are related to a purse. Alternatively, a sample product image maybe uploaded as an example of the product that may trigger the advertisement. The uploaded product is then stored with a link to a specific advertisement or promotion. When a user views an object that matches the uploaded product, the linked advertisement is displayed on the user's augmented reality device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

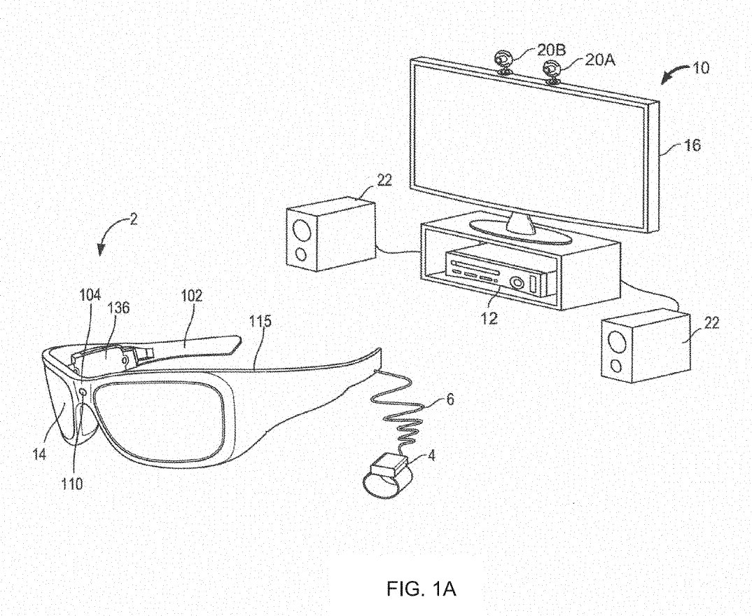

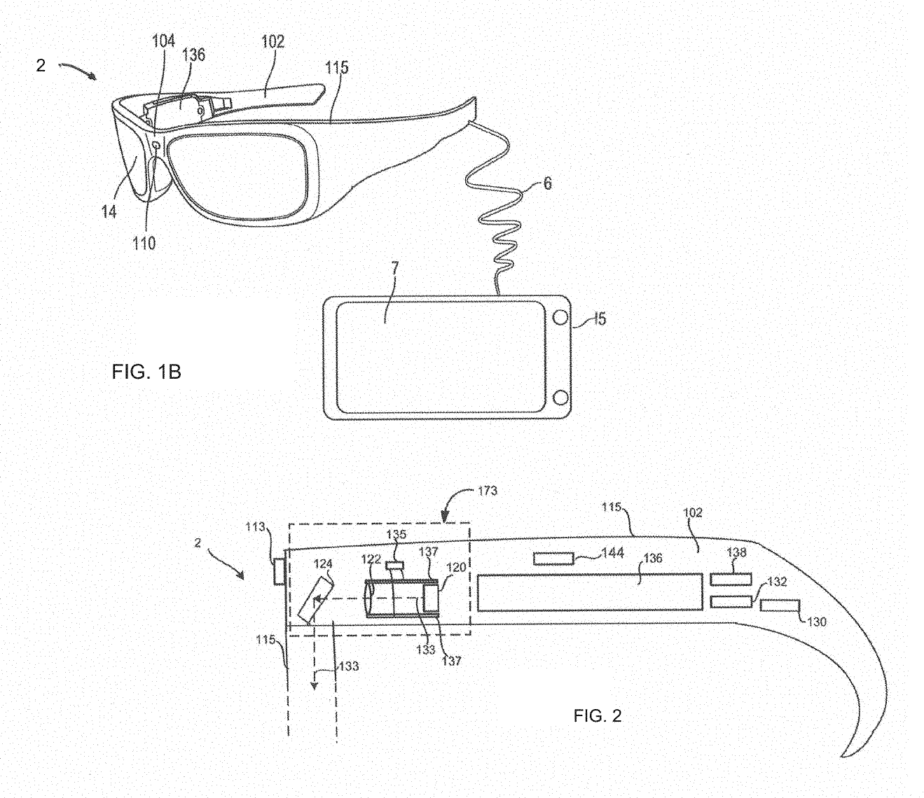

FIG. 1A is a block diagram depicting example components of one embodiment of a display device in a system environment in which the device may operate according to an embodiment of the present invention. System 10 includes a display device such as a near-eye, head mounted display device 2 in communication with processing unit 4 via wire 6. In other embodiments, display device 2 communicates with processing unit 4 via wireless communication. Processing unit 4 may take various embodiments. In some embodiments, processing unit 4 is a separate unit which may be worn on the user's body, e.g., the wrist in the illustrated example or in a pocket, and includes much of the computing power used to operate the display device 2. Processing unit 4 may communicate wirelessly (e.g., WiFi, Bluetooth, infra-red, or other wireless communication means) to one or more hub computing systems 12, hot spots, cellular data networks, etc. In other embodiments, the functionality of the processing unit 4 may be integrated in software and hardware components of the display device 2.

The display device 2, which in one embodiment is in the shape of eyeglasses in a frame 115, is carried by or worn by a user so that the user can see through a display, embodied in this example as a display optical system 14 for each eye, and thereby have an actual direct view of the space in front of the user. The use of the term “actual direct view” refers to the ability to see real world objects directly with the human eye, rather than seeing created image representations of the objects. For example, looking through glass at a room allows a user to have an actual direct view of the room, while viewing a video of a room on a television is not an actual direct view of the room. Based on the context of executing software, for example, a gaming application, the system can project images of virtual objects, sometimes referred to as virtual images, on the display device that is viewable by the person carrying or wearing the display device while that person is also viewing real world objects on or through the display device.

Frame 115 provides a support for holding elements of the system in place as well as a conduit for electrical connections. In this embodiment, frame 115 provides a convenient eyeglass frame as support for the elements of the system discussed further below. In other embodiments, other support structures can be used. An example of such a structure is a visor, hat, helmet or goggles. The frame 115 includes a temple or side arm for resting on each of a user's ears. Temple 102 is representative of an embodiment of the right temple and includes control circuitry 136 for the display device 2. Nose bridge 104 of the frame includes a microphone 110 for recording sounds and transmitting audio data to processing unit 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. An application may be executing on hub computing system 12, the display device 2, as discussed below on a mobile device 15 having display 7 or a combination of these.

In one embodiment, the hub computing system 12 further includes one or more capture devices, such as capture devices 20A and 20B. The two capture devices can be used to capture the room or other physical environment of the user but are not necessary for use with see through display device 2 in all embodiments.

Capture devices 20A and 20B may be, for example, cameras that visually monitor one or more user's and the surrounding space such that gestures and/or movements performed by the one or more users, as well as the structure of the surrounding space, may be captured, analyzed, and tracked to perform one or more controls or actions within an application and/or animate an avatar or on-screen character.

Hub computing system 12 may be connected to an audiovisual device 16 such as a television, a monitor, a high-definition television (HDTV), or the like that may provide game or application visuals. In some instances, the audiovisual device 16 may be a three-dimensional display device. In one example, audiovisual device 16 includes internal speakers. In other embodiments, audiovisual device 16, a separate stereo or hub computing system 12 is connected to external speakers 22.

It is noted that display device 2 and processing unit 4 can be used without hub computing system 12, in which case processing unit 4 will communicate with a WiFi network, a cellular network or other communication means.

FIG. 1B is a block diagram depicting example components of another embodiment of a display device according to the present invention. In this embodiment, the display device 2 communicates with a mobile device 15 having a display 7 as an example embodiment of the processing unit 4. In the illustrated example, the mobile device 15 communicates via wire 6, but communication may also be wireless in other examples.

Furthermore, as in the hub computing system 12, gaming and non-gaming applications may execute on a processor of the mobile device 15 which user actions control or which user actions animate an avatar as may be displayed on a display 7 of the mobile device 15. The mobile device 15 also provides a network interface for communicating with other computing devices such as hub computing system 12 over the Internet or via another communication network via a wired or wireless communication medium using a wired or wireless communication protocol. A remote network accessible computer system like hub computing system 12 may be leveraged for processing power and remote data access by a processing unit 4 like mobile device 15.

In some embodiments, gaze detection of each of a user's eyes is based on a three dimensional coordinate system of gaze detection elements on a display device 2, such as eyeglasses, in relation to one or more human eye elements such as a cornea center, a center of eyeball rotation and a pupil center. Examples of gaze detection elements which may be part of the coordinate system including glint generating illuminators and at least one sensor for capturing data representing the generated glints. As discussed below, a center of the cornea can be determined based on two glints using planar geometry. The center of the cornea links the pupil center and the center of rotation of the eyeball, which may be treated as a fixed location for determining an optical axis of the user's eye at a certain gaze or viewing angle.

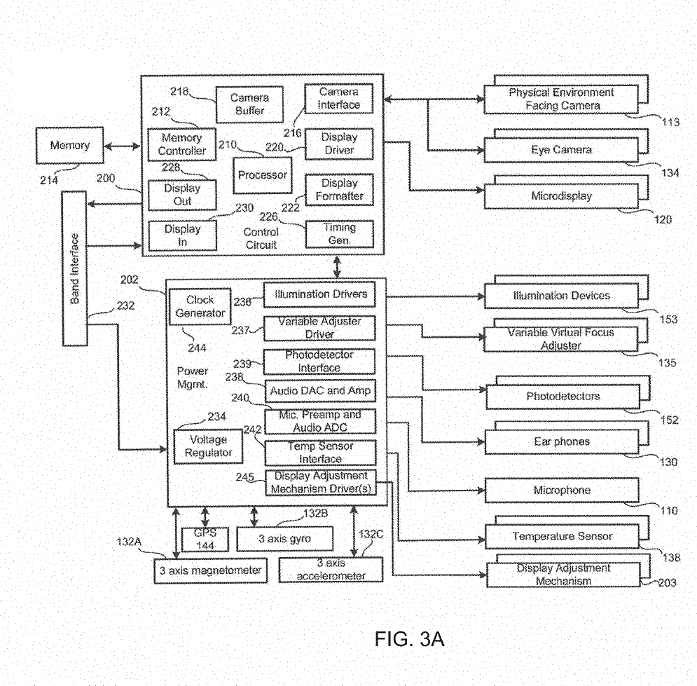

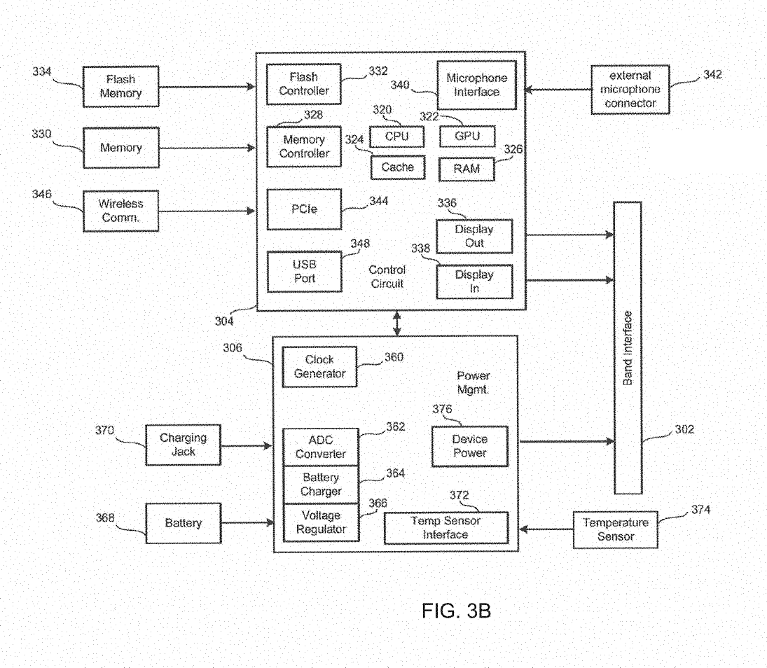

FIG. 2 is a side view of an eyeglass temple of the frame for augmented reality eyeglasses according to an embodiment of the present invention. The following description of a display device is intended to be exemplary only; the concepts of the present invention may be implemented by any type of augmented reality device known to those of skill in the art. With reference to FIG. 2, the front of eyewear frame 115 includes a physical environment facing video camera 113 that can capture video and still images. Particularly in some embodiments, physical environment facing camera 113 may be a depth camera as well as a visible light or RGB camera. For example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a charge-coupled device (CCD) or other type of depth sensor. Other types of visible light camera (RGB camera) and depth cameras can be used. More information about depth cameras can be found in U.S. Pat. No. 8,675,981, which is incorporated herein by reference in its entirety. The data from the sensors may be sent to a processor 210 of the control circuitry 136 (see FIG. 3A where the control circuit is labeled 200), or the processing unit 4, 5 or both which may process them but which the unit 4, 5 may also send to a computer system over a network or hub computing system 12 for processing. The processing identifies objects through image segmentation and edge detection techniques and maps depth to the objects in the user's real world field of view. Additionally, the physical environment facing camera 113 may also include a light meter for measuring ambient light.

Control circuitry 136 provide various electronics that support the other components of the display device 2. More details of control circuitry 136 are provided below with respect to FIGS. 3A and 3B. Inside, or mounted to temple 102, are ear phones 130, inertial sensors 132, GPS transceiver 144 and temperature sensor 138. In one embodiment inertial sensors 132 include a three axis magnetometer 132A, three axis gyro 132B and three axis accelerometer 132C (See FIG. 3A). The inertial sensors are for sensing position, orientation, and sudden accelerations of the display device 2. From these movements, head position may also be determined.

The display device 2 provides an image generation unit which can create one or more images including one or more virtual objects. In some embodiments a microdisplay may be used as the image generation unit. A microdisplay assembly 173 in this example comprises light processing elements and a variable focus adjuster 135. An example of a light processing element is a microdisplay unit 120. Other examples include one or more optical elements such as one or more lenses of a lens system 122 and one or more reflecting elements. Lens system 122 may comprise a single lens or a plurality of lenses.

Mounted to or inside temple 102, the microdisplay unit 120 includes an image source and generates an image of a virtual object. The microdisplay unit 120 is optically aligned with the lens system 122 and the reflecting surface 124 or reflecting surfaces (not shown). The optical alignment may be along an optical axis 133 or an optical path 133 including one or more optical axes. The microdisplay unit 120 projects the image of the virtual object through lens system 122, which may direct the image light, onto reflecting element 124 which directs the light into a lightguide optical element as is known in the art. The combination of views is directed into a user's eye.

The variable focus adjuster 135 changes the displacement between one or more light processing elements in the optical path of the microdisplay assembly or an optical power of an element in the microdisplay assembly. The optical power of a lens is defined as the reciprocal of the focal length, i.e., 1/focal length. The change in focal length results in a change in the region of the field of view, e.g., a region at a certain distance, which is in focus for an image generated by a microdisplay assembly.

In one example of the microdisplay assembly making displacement changes, the displacement changes are guided within an armature 137 supporting at least one light processing element such as the lens system 122 and the microdisplay 120 in this example. The armature 137 helps stabilize the alignment along the optical path 133 during physical movement of the elements to achieve a selected displacement or optical power. In some examples, the adjuster 135 may move one or more optical elements such as a lens in lens system 122 within the armature 137. In other examples, the armature may have grooves or space in the area around a light processing element so the armature slides over the element, for example, microdisplay 120, without moving the light processing element. Another element in the armature such as the lens system 122 is attached so that the system 122 or a lens within slides or moves with the moving armature 137. The displacement range is typically on the order of a few millimeters (mm). In one example, the range is 1-2 mm. In other examples, the armature 137 may provide support to the lens system 122 for focal adjustment techniques involving adjustment of other physical parameters than displacement. An example of such a parameter is polarization.

FIG. 3A is a block diagram of one embodiment of hardware and software components of a display device according to an embodiment of the present invention. In this embodiment, display device 2 receives instructions about a virtual image from processing unit 4, 5 and provides the sensor information back to processing unit 4, 5. Software and hardware components which may be embodied in a processing unit 4, 5 are depicted in FIG. 3B, will receive the sensory information from the display device 2 and may also receive sensory information from hub computing device 12 (See FIG. 1A). Based on that information, processing unit 4, 5 will determine where and when to provide a virtual image to the user and send instructions accordingly to the control circuitry 136 of the display device 2.

It is noted that some of the components of FIG. 3A (e.g., physical environment facing camera 113, eye camera 134, variable virtual focus adjuster 135, photodetector interface 139, micro display 120, photodetectors 152, illumination device 153 or illuminators, earphones 130, temperature sensor 138, display adjustment mechanism 203) are shown in shadow to indicate that there are at least two of each of those devices, at least one for the left side and at least one for the right side of head mounted display device 2. FIG. 3A shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230. In one embodiment, all of components of control circuit 220 are in communication with each other via dedicated lines of one or more buses. In another embodiment, each of the components of control circuit 200 are in communication with processor 210.

Camera interface 216 provides an interface to the two physical environment facing cameras 113 and each eye camera 134 and stores respective images received from the cameras 113, 134 in camera buffer 218. Display driver 220 will drive microdisplay 120. Display formatter 222 may provide information, about the virtual image being displayed on microdisplay 120 to one or more processors, e.g., 4, 5, 210, of one or more computer systems, e.g., 5, performing processing for the augmented reality system. Timing generator 226 is used to provide timing data for the system. Display out 228 is a buffer for providing images from physical environment facing cameras 113 and the eye cameras 134 to the processing unit 4, 5. Display in 230 is a buffer for receiving images such as a virtual image to be displayed on microdisplay 120. Display out 228 and display in 230 communicate with band interface 232 which is an interface to processing unit 4, 5.

Power management circuit 202 includes voltage regulator 234, eye tracking illumination drivers 236, variable adjuster driver 237, photodetector interface 239, audio digital-to-analog converter (DAC) and amplifier 238, microphone preamplifier and audio audio-to-digital converter (ADC) 240, temperature sensor interface 242, display adjustment mechanism driver(s) 245 and clock generator 244. Voltage regulator 234 receives power from processing unit 4, 5 via band interface 232 and provides that power to the other components of head mounted display device 2. Illumination driver 236 controls, for example via a drive current or voltage, the illumination devices 153 to operate about a predetermined wavelength or within a wavelength range. Audio DAC and amplifier 238 receives the audio information from earphones 130. Microphone preamplifier and audio ADC 240 provides an interface for microphone 110. Temperature sensor interface 242 is an interface for temperature sensor 138. One or more display adjustment drivers 245 provide control signals to one or more motors or other devices making up each display adjustment mechanism 203 which represent adjustment amounts of movement in at least one of three directions. Power management unit 202 also provides power and receives data back from three axis magnetometer 132A, three axis gyro 132B and three axis accelerometer 132C. Power management unit 202 also provides power and receives data back from and sends data to GPS transceiver 144.

The variable adjuster driver 237 provides a control signal, for example a drive current or a drive voltage, to the adjuster 135 to move one or more elements of the microdisplay assembly 173 to achieve a displacement for a focal region calculated by software executing in a processor 210 of the control circuitry 13, or the processing unit 4,5 or the hub computer 12 or both. In embodiments of sweeping through a range of displacements and, hence, a range of focal regions, the variable adjuster driver 237 receives timing signals from the timing generator 226, or alternatively, the clock generator 244 to operate at a programmed rate or frequency.

The photodetector interface 239 performs any analog to digital conversion needed for voltage or current readings from each photodetector, stores the readings in a processor readable format in memory via the memory controller 212, and monitors the operation parameters of the photodetectors 152 such as temperature and wavelength accuracy.

FIG. 3B is a block diagram of one embodiment of the hardware and software components of a processing unit with a see-through, near-eye, mixed reality display unit according to an embodiment of the present invention. The mobile device 15 may include this embodiment of hardware and software components as well as similar components which perform similar functions. FIG. 3B shows controls circuit 304 in communication with power management circuit 306. Control circuit 304 includes a central processing unit (CPU) 320, graphics processing unit (GPU) 322, cache 324, RAM 326, memory control 328 in communication with memory 330 (e.g., D-RAM), flash memory controller 332 in communication with flash memory 334 (or other type of non-volatile storage), display out buffer 336 in communication with see-through, near-eye display device 2 via band interface 302 and band interface 232, display in buffer 338 in communication with near-eye display device 2 via band interface 302 and band interface 232, microphone interface 340 in communication with an external microphone connector 342 for connecting to a microphone, PCI express interface for connecting to a wireless communication device 346, and USB port(s) 348.

In one embodiment, wireless communication component 346 can include a Wi-Fi enabled communication device, Bluetooth communication device, infrared communication device, etc. The USB port can be used to dock the processing unit 4, 5 to hub computing device 12 in order to load data or software onto processing unit 4, 5, as well as charge processing unit 4, 5. In one embodiment, CPU 320 and GPU 322 are the main workhorses for determining where, when and how to insert images into the view of the user.

Power management circuit 306 includes clock generator 360, analog to digital converter 362, battery charger 364, voltage regulator 366, see-through, near-eye display power source 376, and temperature sensor interface 372 in communication with temperature sensor 374 (located on the wrist band of processing unit 4). An alternating current to direct current converter 362 is connected to a charging jack 370 for receiving an AC supply and creating a DC supply for the system. Voltage regulator 366 is in communication with battery 368 for supplying power to the system. Battery charger 364 is used to charge battery 368 (via voltage regulator 366) upon receiving power from charging jack 370. Device power interface 376 provides power to the display device 2.

The Figures above provide examples of geometries of elements for a display optical system which provide a basis for different methods of aligning an interpupillary distance (IPD) as discussed in the following Figures. The method embodiments may refer to elements of the systems and structures above for illustrative context; however, the method embodiments may operate in system or structural embodiments other than those described above.

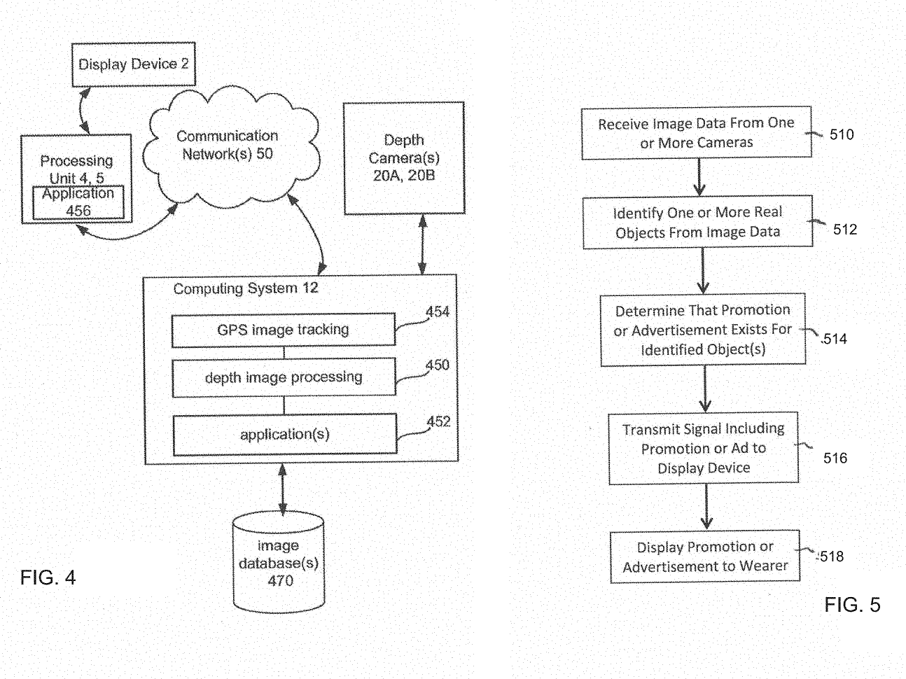

FIG. 4 is a block diagram of a system embodiment for identifying objects using a see-through, near-eye, mixed reality display device according to an embodiment of the present invention. This embodiment illustrates how the various devices may leverage networked computers to map a three-dimensional model of a user field of view and the real and virtual objects within the model. An application 456 executing in a processing unit 4,5 communicatively coupled to a display device 2 can communicate over one or more communication networks 50 with a computing system 12 for processing of image data to determine and track a user field of view in three dimensions. The computing system 12 may be executing an application 452 remotely for the processing unit 4,5 for providing images of one or more virtual objects. As mentioned above, in some embodiments, the software and hardware components of the processing unit are integrated into the display device 2. Either or both of the applications 456 and 452 working together may map a 3D model of space around the user. A depth image processing application 450 detects objects, identifies objects and their locations in the model. The application 450 may perform processing based on depth image data from depth camera such as cameras 20A and 20B, two-dimensional or depth image data from one or more front facing cameras 113, and GPS metadata associated with objects in the image data obtained from a GPS image tracking application 454.

The GPS image tracking application 454 identifies images of the user's location in one or more image database(s) 470 based on GPS data received from the processing unit 4,5 or other GPS units identified as being within a vicinity of the user, or both. Additionally, the image database(s) may provide accessible images of a location with metadata like GPS data and identifying data uploaded by users who wish to share the images. The GPS image tracking application provides distances between objects in an image based on GPS data to the depth image processing application 450. Additionally, the application 456 may perform processing for mapping and locating objects in a 3D user space locally and may interact with the GPS image tracking application 454 for receiving distances between objects. Many combinations of shared processing are possible between the applications by leveraging network connectivity.

FIG. 5 is a flowchart of a method embodiment for identifying an object in the user's field of view of a display device and retrieving a related advertisement for the specific product according to an embodiment of the present invention. In step 510, one or more processors of the control circuitry 136, the processing unit 4,5, the hub computing system 12 or a combination of these receive image data from one or more front facing cameras 113 (see FIG. 2), where the image data represents an image of a product; i.e., the given product, received from the image capturing device. In the embodiment of FIGS. 1-4, the image capturing device is an augmented reality vision device 2. Other image capturing devices may be used. In step 512, the system identifies the given product from a catalog of products which is intended to encompass a database of products for which an image has been stored. The given product is one or more real objects that substantially match the image(s) of products stored in the catalog or database of product images. In accordance with the invention, the given product may vary to some degree; e.g., color, size, material, etc. from the image of a product captured by the image capturing device while “substantially matching” the captured image while taking into account product variations due to, for example, color, size, material, real-world product tolerances and aesthetics. The given product may substantially match the stored image even if it is within the same category of products without being an exact match in every regard. One product would substantially match another product for purposes of this invention so long as the user would have a commercial interest in the matching product when viewing the original product. For example, when a user is viewing a television, a product that substantially matches would be any similar type of television as determined by the category of products defined by the system. Here, the identification of the real object(s) or given product is based on image data or identification may be based on QR or barcodes for the product(s) at issue. The specific implementation of step 512 will be described in more detail below. At step 514, the system of FIGS. 3A and 3B will determine that a promotion or advertisement exists for the object identified in step 512; i.e., the given product. When such a promotion or advertisement exists, then at step 516, the system will transmit a signal including the promotion to the display and at step 518, the display device 2 will display the relevant promotion or advertisement in the display device 2 of FIGS. 1A and 1B to the user.

In some embodiments, each front facing camera is a depth camera providing depth image data or has a depth sensor for providing depth data which can be combined with image data to provide depth image data. The one or more processors of the control circuitry, e.g., 210, and the processing unit 4, 5 identify one or more real objects including three-dimensional positions in a user's field of view based on the depth image data from the front facing cameras.

Additionally, orientation sensor 132 data may also be used to refine which image data currently represents the user's field of view. Additionally, a remote computer system 12 may also provide additional processing power to the other processors for identifying the objects and mapping the user field of view based on depth image data from the front facing image data. U.S. Pat. No. 8,494,909, which is hereby incorporated by reference in its entirety, describes methodology for automatic learning in a product identification environment using visual recognition. The present invention may utilize scanning of barcodes and/or QR codes for the relevant product and/or may utilize a comprehensive, automatic-learning database of product images to identify objects in the user's field of vision.

An alternate embodiment of the present invention includes a probability analysis, where the system determines a probability that the user of the display device will purchase the given product in a category of similar products. The system utilizes statistical analysis of the historical data including the user's purchase history as well as a record to the products being viewed by the user. Based on the collected data, the system will calculate a probability of the likelihood that the user will purchase a given product or a product within a category of products, for example, based on a historical database recording prior purchaser's by the user when products are on sale. Based on the sale example, the system may determine that the user is 40% more likely to purchase products on sale versus products not on sale. Once the calculated probability exceeds a predetermined value, the system will determine that a given message for the given product is predicted to increase the probability to a least a threshold such that the user will purchase the given product and, when these criteria are met, the system send a promotional message to the user. In an alternate embodiment, the system determines a location of the display device monitor objects in a field of view of the display device. The system then determine that a real-time activity of the user, such as viewing a product multiple times in a given time period, indicates an increased likelihood of purchasing the given product. When the likelihood exceeds a predetermined value, the system will again send a promotional message to the user.

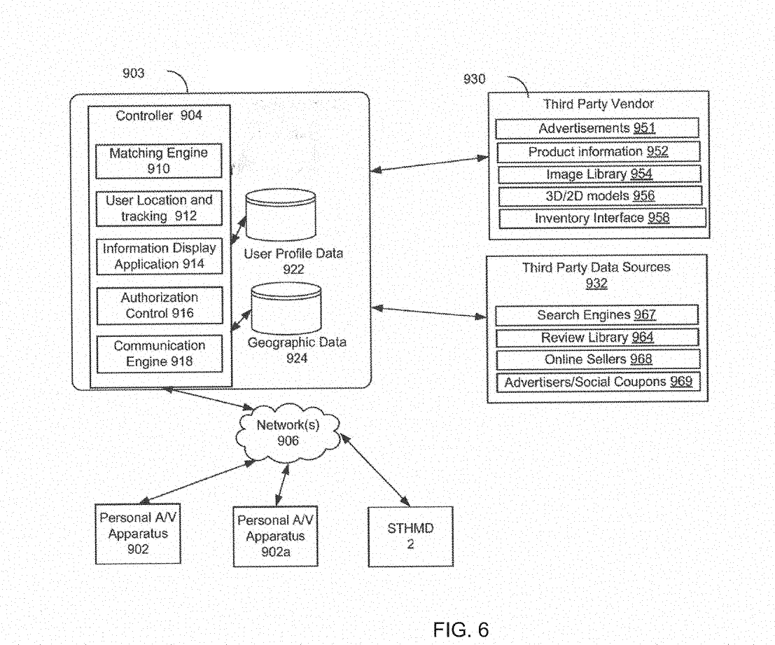

FIG. 6 shows an example of system architecture for one or more processes and/or software for providing augmentation information to a user from a supplemental information provider according to an embodiment of the present invention. Supplemental Information Provider 903 may create and provide augmentation data, transmit augmentation data provided by others, store user profile information used to provide the augmentation data intelligently, and/or may provide services which transmit event or location data from third party data providers 930 or third party data sources 932 to a user's personal NV apparatus 902. Multiple supplemental information providers and third party event data providers may be utilized with the present technology. A supplemental information provider 903 may include one or more of data storage for a user's profile information 922, and user location historical geographic data 924. The supplemental information provider 903 includes a controller 904 which has functional components including an augmentation matching engine 910, user location and tracking data 912, information display applications 914, and an authorization component 916 and a communication engine 918.

It should be understood that the supplemental information provider 903 may comprise any one or more of the processing devices described herein, or a plurality of processing devices coupled via one or more public and private networks 906 to users having person audio/visual apparatuses 902, 902a which may include one or more see through head mounted displays 2.

Supplemental Information Provider 903 can collect data from different sources to provide augmentation data to a user who accepts information from the provider. In one embodiment, a user will register with the system and agree to provide the Provider 903 with user profile information to enable intelligent augmentation of information by the Provider 903. User profile information may include, for example, user shopping lists, user task lists, user purchase history, user reviews of products purchased, and other information which can be used to provide augmentation information to the user. User location and tracking module 912 keeps track of various users which are utilizing the system. Users can be identified by unique user identifiers, location and other elements. The system may also keep a record of retail establishments that a user has visited and locations that a user is close to. An information display application 914 allows customization of both the type of display information to be provided to user's and the manner in which the information is displayed. The information display application 914 can be utilized in conjunction with an information display application on the personal A/V apparatus 902. In one embodiment, the display processing occurs at the Supplemental Information Provider 904. In alternative embodiments, information is provided to personal A/V apparatus 902 so that personal A/V apparatus 902 determines which information should be displayed and where, within the display, the information should be located. Third party supplemental information providers 930. 932 can provide various types of data for various types of events, as discussed herein.

Various types of information display applications can be utilized in accordance with the present technology. Different applications can be provided for different events and locations. Different providers may provide different applications for the same live event. Applications may be segregated based on the amount of information provided, the amount of interaction allowed or other feature. Applications can provide different types of experiences within the event or location, and different applications can compete for the ability to provide information to user's during the same event or at the same location. Application processing can be split between the application on the supplemental information providers 904 and on the personal A/V apparatus 902.

Third-party vendors 930 may comprise manufacturers or sellers of goods and products who desire to provide or interact with supplemental information provider 903 to provide augmentation information to user's of personal A/V apparatuses. Third-party vendors 930 may provide or allow supplemental information providers access to specific product information 952, image libraries of products 954, 3D and 2D models of products 956, and real or static inventory data 958. Utilizing this third-party vendor information, the supplemental information provider 903 can augment the view of a user of a see through head mounted display 2 based on the location and gaze of the user to provide additional information about objects or products the user is looking at. In addition, the supplemental information provider can provide specific targeted advertising and promotional material from the third-party vendor or other data services. Third-party data sources 932 may comprise any data source which is useful to provide augmented information to users. This can include Internet search engine data 962, libraries of product reviews 964, information from private online sellers 966, and advertisers 968. Third-party vendors may include advertising data 951 as well.

It will be understood that many other system level architectures may be suitable for use with the present technology.

By way of example, an advertisement for specific headphone product is created on the system of the invention for 20% off. The marketer can upload an image to “teach” the system which object(s) to link to a specific advertisement. The image and the link to the advertisement or promotion would be stored in the appropriate third-party vendor 930 database.

A user with an augmented reality device (e.g., Google Glass) would wear the device as the user normally would today. The augmented reality device would passively monitor and detect items in view of the user through (1) scanning of barcodes/qr codes; and/or image recognition techniques (e.g., using the camera of the device). A barcode is an optical, machine-readable, representation of data; the data usually describes something about the object that carries the barcode. A QR code consists of black squares arranged in a square grid on a white background, which can be read by an imaging device such as a camera, and processed using Reed-Solomon error correction until the image can be appropriately interpreted. The required data is then extracted from patterns that are present in both horizontal and vertical components of the image.

Once the device 2 identifies the headphone product, the system would perform a lookup to see if there are any relevant advertisements/promotions for the headphone product. If a related advertisement or promotion for the headphone product exists, then the system would display the promotion/advertisements in the user's or user's augmented field of view. Optionally, the advertisement may include pricing information (useful for when at a competitor's store), and the system may include an actionable link (e.g., the ability to follow to checkout and complete a purchase).

Additionally, the system may include comparison data for related items. For example, if the user is looking at the physical headphone product at Best Buy, the system may display the price on Amazon for $5 less to encourage the user to instead make the purchase online. The present invention also includes the provision where a user is viewing a product on-line (e.g., on a laptop) and the system will identify the product being viewed and conduct the same analysis to determine of any relevant promotions or advertisements exist for the product at issue.

As an alternate embodiment or enhancement to the invention, the system may include an incremental counter to recognize when the product at issue is identified as being viewed by the user. In this case, the incremental counter could be an optional preference such that the advertisement is only retrieved or shown after the product is viewed a certain number of times. For example, if a user views the item, walks away, then comes back, the system recognizes that the user has looked at the product twice or more. That struggle could indicate that the user is unsure whether to make the purchase. Therefore, the system only shows the ad the second time as the user has shown some interest.

Additionally, the system may perform a lookup on the user's location to determine if situation could result in a purchase decision. For example, perhaps the advertiser only wants to show the advertisement when the user is in the situation where the user could make a purchase. Thus, if the user were at the park the user is likely unable to make a purchase right then. Whereas if the user were standing in a competitors store in front of televisions.

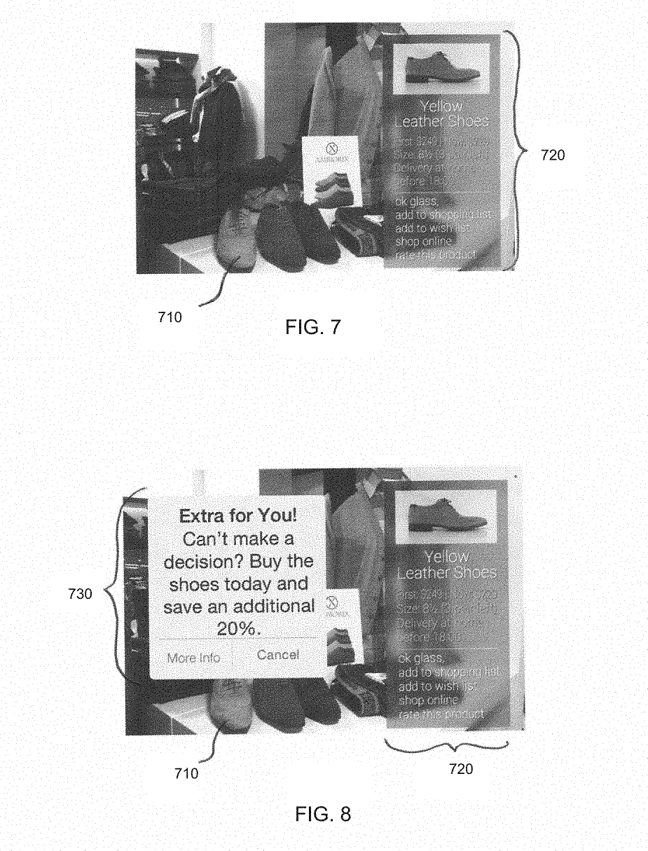

FIG. 7 is a schematic representation of a user's view of an object of interest during a shopping experience according to an embodiment of the present invention. FIG. 8 is a schematic representation of a user's view of an object of interest during a shopping experience with a displayed promotion according to an embodiment of the present invention. With reference to FIGS. 7 and 8, another example will be described. Bob is shopping at his favorite retailer. Bob is unsure about whether or not to purchase a pair of shoes. Bob looks at the shoes a first time and even uses the augmented reality glasses to pull up product information about the shoes as illustrated in FIG. 7. Specifically, Bob is viewing the yellow leather shoes 710 and Bob retrieves product information 720 that is displayed in Bob's field of view by the augmented reality glasses worn by Bob. In this example, Bob walks away from the shoes 710 and comes back a second time. This time Bob doesn't manually lookup the product information 720. However, because the camera on his augmented reality glasses recognized the shoes 710 and also recognized that this is the second (or third or fourth) time that Bob has come back to these shoes 710 within the last hour, the system will display Bob a corresponding promotion 730 for the shoes as shown in FIG. 8. Similarly, the present invention may calculate and determine a length of time a user has viewed a particular product and send a promotional message to the user when the length of time exceeds a predetermined value. Additionally, another “criteria” a marketer may also require is having the person look at the same (or similar) product at a different locations. For example, if Mary looks at the Polo Shirt in Macy's Store A and the same shirt at Macy's Store B, the system may send the message or notification regardless of location, particularly when the two stores are within a specified threshold distance. This location measuring aspect may be accomplished using existing location tracking technologies in mobile devices or located in the augmented reality glasses or other device.

Of course, many variations are possible. For example, the advertiser may set a threshold of how many times the advertiser will wait before displaying an advertisement 730 or an amount of time lapse before the advertisement/promotion 730 is displayed. It is noted that the promotion/advertisement 730 does not have to be textual, but can also be an image, set of images, video or other media. Likewise, the foregoing examples refer to augmented reality glasses, but the present invention may be employed using any type of device having a camera or video whether or not the device includes augmented reality capabilities. For example, a user's mobile phone may perform the method and comprise the system of the invention set forth herein.

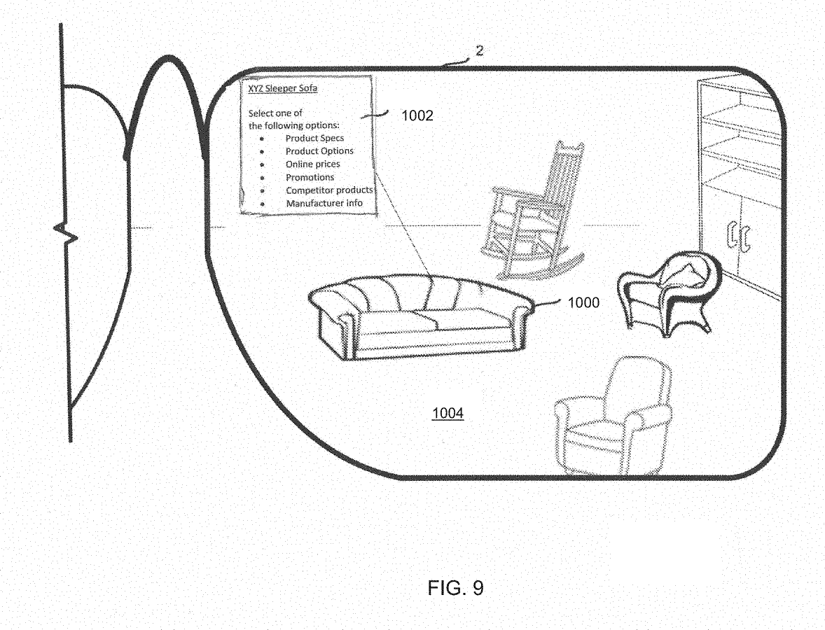

FIG. 9 illustrates another alternative use of the technology providing augmentation information to a user in which the user has entered a store, such as a furniture store, according to an embodiment of the present invention. The device 2 displays a number of pieces of furniture, during which the user's gaze fixes on a sofa 1000. FIG. 9 represents one example user's view of the sofa 1000 within the furniture store 1004. When the user fixes his gaze on the sofa 1000, augmentation information 1002 can be provided. In this case, the augmentation information presented is a description of the sofa 1000 along with a menu allowing the user to select any of a number of different types of augmentation information which can additionally be presented in the view of the display device 2. In augmentation information 1002, the user has a number of choices that the user can make by simply selecting the virtual menu item on the virtual menu of the augmentation information 1002. The user can select more information for the “product specs,” “product options,” “online prices,” “promotions,” “competitor products,” and “manufacturer info”. Selecting any of the menu items will result in actions which are generally described by the menu items. For example, selecting “online prices” will render a list of online prices that are available from online retailers for the sofa 1000. Selecting “product options” could show the user a list of types of fabrics and color options which are available for a particular product. The type of product options which are available for different types of products can vary greatly based on the type of product. Selecting “manufacturer info” can provide a product brochure or other information which has been provided by the manufacturer and which is specific to the product 1000.

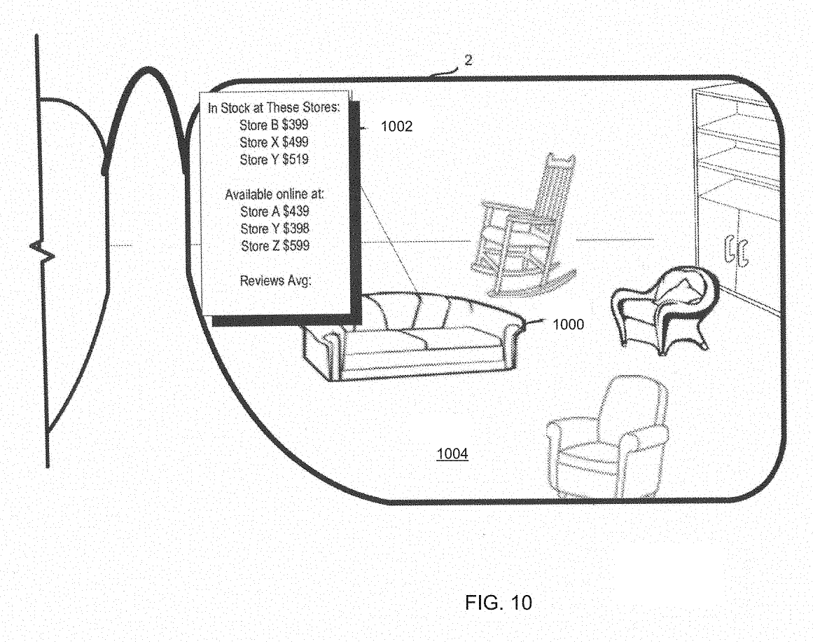

FIG. 10 represents an example of the information provided by selecting an option from the advertisement in FIG. 9 according to an embodiment of the present invention. As shown in FIG. 10, this option can display a selection of stores which have the same item in stock as well as online (Web-based) sellers that are selling the product. In addition, online reviews can be presented in 1002. Any number of augmentation information types can be presented in accordance with the teachings of FIGS. 9 and 10.

In one sense, the invention provides a technological advance in the art of dynamic image transmission and display. The present invention provides a dynamic transmission of image data related to an item or product within the user's field of vision then responds with a signal transmitted back to the user, wherein the signal provides an image to the user related to the product being concurrently viewed by the user in real time. On example may include a user viewing a work of art or a historical monument using an image capturing device. The system of this invention would transmit a signal back to the image capturing device with an image to be displayed to the user. The signal sent back to the user in this example may be historical data about the art or the historical monument. The dynamic capturing, transmission and display of related data provides a substantial improvement over the known art.

It is understood in advance that although this disclosure includes a detailed description on many computing platforms, including cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

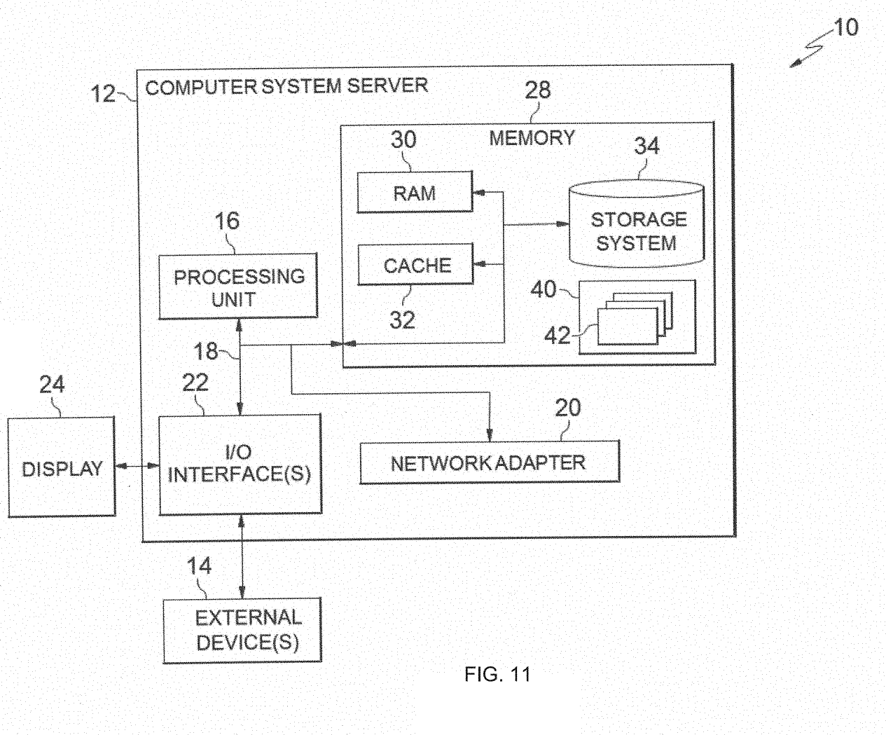

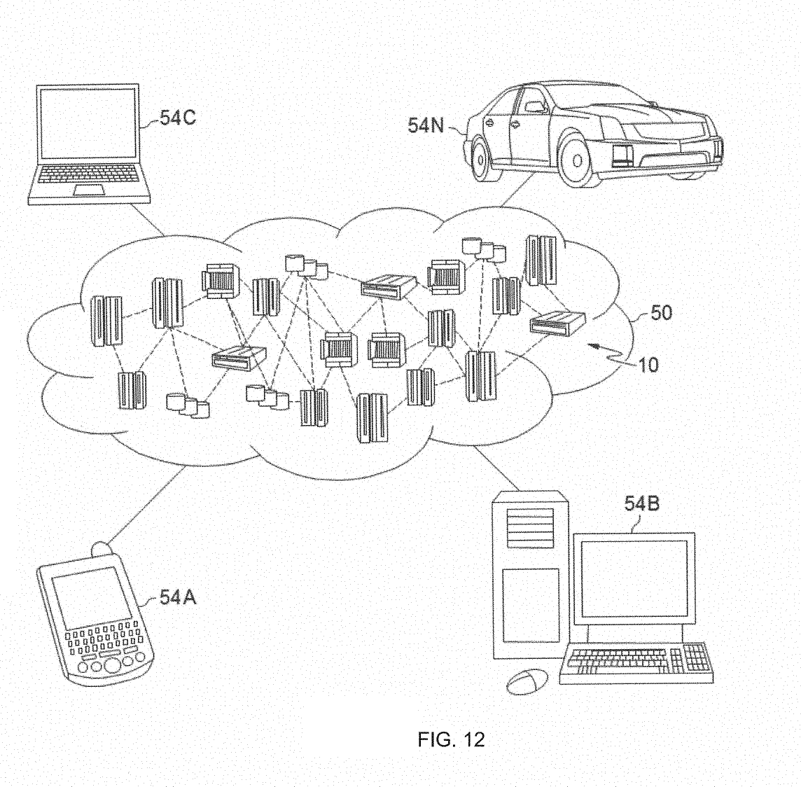

Referring now to FIG. 11, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and may include both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 12, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. The nodes 10 may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 12 are intended to be illustrative only and that computing nodes 10 and cloud computing environment 50 can communicate with any type of computerized device over any type of network and/or network addressable connection (e.g., using a web browser).

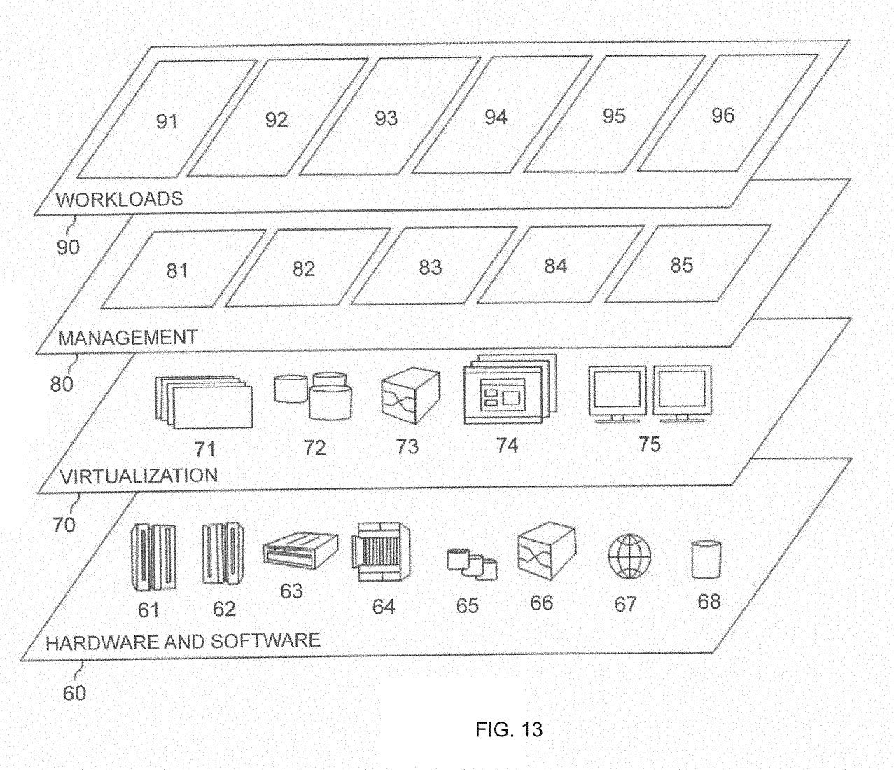

Referring now to FIG. 13, a set of functional abstraction layers provided by cloud computing environment 50 (FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the real-time object identification and promotional display system 96 as described with respect to FIGS. 1-10.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method of dynamically capturing, transmitting and displaying images for a user of an image capturing device carried by the user, the method comprising:
receiving, by a computer in real-time, image data representing an image of a product, said image data being received from said image capturing device while said image capturing device is viewing said product;
identifying, by the computer in real-time, a given product from a catalog of products stored in a database, said identifying the given product based on said image data, said given product substantially matching said image of said product;
determining, by the computer in real-time, that promotional material exists for said given product; and
transmitting, by the computer in real-time, a signal including said promotional material to said image capturing device, said signal triggering, in real-time, a display of said promotional material by said image capturing device to said user.

2. The method of claim 1, wherein said image capturing device is an augmented reality visual device worn by the user, and wherein said triggering, in real time, said display of said promotional material includes triggering, in real time, said display of said promotional material within a field of vision of said user.

3. The method of claim 1, wherein said triggering said display, in real time, of said promotional material occurs while said image capturing device is viewing said product.

4. The method of claim 1, wherein said image data representing said image of said product is visual data of a visual representation of said product.

5. The method of claim 1, further comprising:
incrementing, by the computer in real-time, a counter in response to said identifying, by the computer in real-time, the given product, said counter cumulating, via said incrementing, a number of times said given product is identified by the computer, and wherein said triggering, in real-time, said display of said promotional material is performed in response to said counter exceeding a predetermined threshold value.

6. The method of claim 1, further comprising:
measuring, by the computer in real-time, an amount of time said image capturing device has been viewing said image of said product, and wherein said triggering in real time said display of said promotional material is performed in response to said amount of time exceeding a predetermined value.

7. The method of claim 1, further comprising:
monitoring, by the computer in real-time, a physical location of said image capturing device;
determining, by the computer in real-time, that said given product has been identified more than once, and wherein said triggering said display of said promotional material is performed after said image data has been received from different physical locations.

8. The method of claim 1, wherein said identifying comprises identifying variant products included in a category of products defined by said given product, said variant products varying to some degree from said image of said given product.

9. The method of claim 1, further comprising:
determining, by the computer, a probability that the user of said device will purchase said given product in a category of similar products;
determining, by the computer, that a given message for the given product is predicted to increase the probability to a least a threshold such that the user will purchase the given products; and
sending the message to the user.

10. The method of claim 1, further comprising:
determining, by the computer, a location of said device;
monitoring, by the computer, objects in a field of view of the device; and
determining, by the computer, that a real-time activity of the user of said device indicates an increased likelihood of purchasing the given product.

11. A computer program product comprising:
a computer-readable storage device; and
a computer-readable program code stored in the computer-readable storage device, the computer readable program code containing instructions executable by a processor of a computer system to implement a method of dynamically capturing, transmitting and displaying images for a user of an image capturing device carried by the user, the method comprising:
receiving, by a computer in real-time, image data representing an image of a product, said image data being received from said image capturing device while said image capturing device is viewing said product;
identifying, by the computer in real-time, a given product from a catalog of products stored in a database, said identifying the given product based on said image data, said given product substantially matching said image of said product;
determining, by the computer in real-time, that promotional material exists for said given product; and
transmitting, by the computer in real-time, a signal including said promotional material to said image capturing device, said signal triggering, in real-time, a display of said promotional material by said image capturing device to said user.

12. The computer program product of claim 11, wherein said image capturing device is an augmented reality visual device worn by a user, and wherein said triggering said display in real time of said promotional material includes triggering, in real time, said display of said promotional material within a field of vision of said user.

13. The computer program product of claim 11, wherein said triggering, in real time, said display of said promotional material occurs while said image capturing device is viewing said product.

14. The computer program product of claim 11, wherein said data representing image of said product is visual data of a visual representation of said product.

15. The computer program product of claim 11, said method further comprising:
incrementing, by the computer in real-time, a counter in response to said identifying, by the computer in real-time, the given product, said counter cumulating, via said incrementing, a number of times said given product is identified by the computer, and wherein said triggering, in real-time, said display of said promotional material is performed in response to said counter exceeding a predetermined threshold value.

16. The computer program product of claim 11, said method further comprising:
measuring, by the computer in real-time, an amount of time said image capturing device has been viewing said image of said product, and wherein said triggering in real time said display of said promotional material is performed in response to said amount of time exceeding a predetermined value.

17. A computer system for verifying factual accuracy of an event, the system comprising:
a central processing unit (CPU);
a memory coupled to said CPU; and
a computer readable storage device coupled to the CPU, the storage device containing instructions executable by the CPU via the memory to implement a method of dynamically capturing, transmitting and displaying images for a user of an image capturing device carried by the user, the method comprising the steps of:
receiving, by a computer in real-time, image data representing an image of a product, said image data being received from said image capturing device while said image capturing device is viewing said product;
identifying, by the computer in real-time, a given product from a catalog of products stored in a database, said identifying the given product based on said image data, said given product substantially matching said image of said product;
determining, by the computer in real-time, that promotional material exists for said given product; and
transmitting, by the computer in real-time, a signal including said promotional material to said image capturing device, said signal triggering, in real-time, a display of said promotional material by said image capturing device to said user.

18. The computer system of claim 17, wherein said image capturing device is an augmented reality visual device worn by a user, and wherein said triggering in real time said display of said promotional material includes triggering, in real time, said display of said promotional material within a field of vision of said user.

19. The computer system of claim 17, wherein said triggering, in real time, said display of said promotional material occurs while said image capturing device is viewing said product.

20. The computer system of claim 17, said method further comprising:
incrementing a counter based on a number of times said given product is identified by the computer, and wherein said triggering said display of said promotional material is performed only after said counter exceeds a predetermined value.
